(19) United States
(12) Patent Application Publication
(10) Pub. No.: US 2009/0307861 A1
(43) Pub. Date: Dec. 17, 2009

(54) WIPER FOR AN AUTOMOBILE REARVIEW MIRROR

(76) Inventor: Chiang-Fen LIN, Yongkang City (TW)

Correspondence Address: Chiang-Fen LIN, P.O. BOX 90, Tainan City, 70499, TW

(21) Appl. No.: 12/139,518

(22) Filed: Jun. 16, 2008

(51) Int. Cl. B60S 1/00

(52) U.S. Cl. 15/250.003

(57) ABSTRACT

A wiper for an automobile rearview mirror includes a motor installed on a rear surface of the rearview mirror with a driving gear. A supporting shaft is fixed on the rear surface of the mirror base, having a driven gear for engaging with female threads of the driving gear and having male threads engaging with a movable base that has a magnet to rest on the rear surface of the mirror base. Installed on the mirror is a wiper fitted with a magnet for mutually attracting with the magnet of the movable base. When the motor is turned on, its driving gear will drive the supporting shaft to spin to enable the movable base to move along the supporting shaft. The wiper is attracted by the magnet of the movable base to move to and from the mirror, effectively wiping off the water on the mirror to keep it clear.

### BACKGROUND OF THE INVENTION

1. Field of the Invention

This invention relates to a wiper for an automobile rearview mirror, particularly to one installed with at least a magnet able to mutually attract with magnets fitted in movable bases installed on a rear surface of a mirror base of the rearview mirror. Driven by a motor, at least a supporting pole can start rotating to enable the movable base to move along the supporting pole, so that the wiper can be attracted by the movable base to move on the mirror to wipe off water on it.

2. Description of the Prior Art

Commonly, rearview mirrors positioned at two sides of a vehicle are employed for being watched by a driver to realize the conditions of other vehicles behind the driver no matter if the driver is to make a turn, cut in, switch the lane or park. However, as the rearview mirrors are ever installed outside a vehicle body, they can be easily drenched by rain when raining, enabling the rearview mirrors blurred to make a driver unable to clearly see the conditions of other cars running behind him from the rearview mirrors, possible to affect traffic security.

### SUMMARY OF THE INVENTION

The object of this invention is to offer a wiper for an automobile rearview mirror for wiping off water drops on the mirror so as to enable a driver to clearly see the image on the mirror.

The rearview mirror includes a mirror base having a mirror attached on its front surface and a motor installed on its rear surface. The motor is provided with a driving gear mounted on its shaft. At least a supporting shaft is fixed on the rear surface of the mirror base, provided with a driven gear for engaging with the driving gear of the motor, and plural male threads formed around its surface for engaging with female threads of a movable base, which is provided with a magnet fitted inside it to rest on the rear surface of the mirror base. Installed on the mirror is a wiper fitted with at least a magnet for mutually attracting with the magnet of the movable base.

### BRIEF DESCRIPTION OF DRAWINGS

This invention is better understood by referring to the accompanying drawings, wherein:

FIG. 1 is a perspective view of a preferred embodiment of a wiper for an automobile rearview mirror in the present invention, showing it with a front surface of a mirror base;

FIG. 2 is a rear perspective view of the mirror base in the preferred embodiment of a wiper for an automobile rearview mirror in the present invention;

FIG. 3 is a perspective view of the preferred embodiment of a wiper for an automobile rearview mirror in the present invention, showing it being sheltered in a chamber of the mirror base;

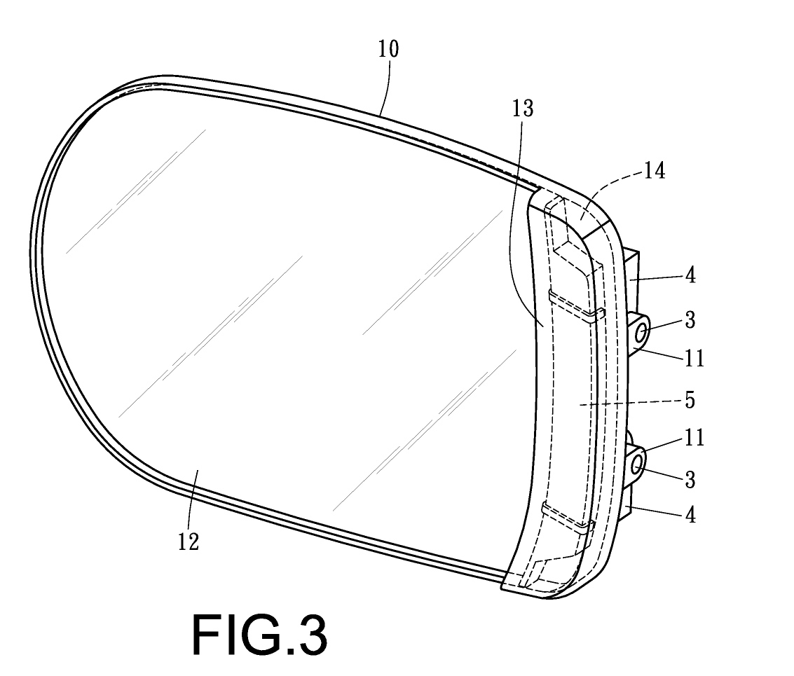

FIG. 4 is a rear view of the of the mirror base in the present invention;

FIG. 5 is a side cross-sectional view of the preferred embodiment of a wiper for an automobile rearview mirror in the present invention;

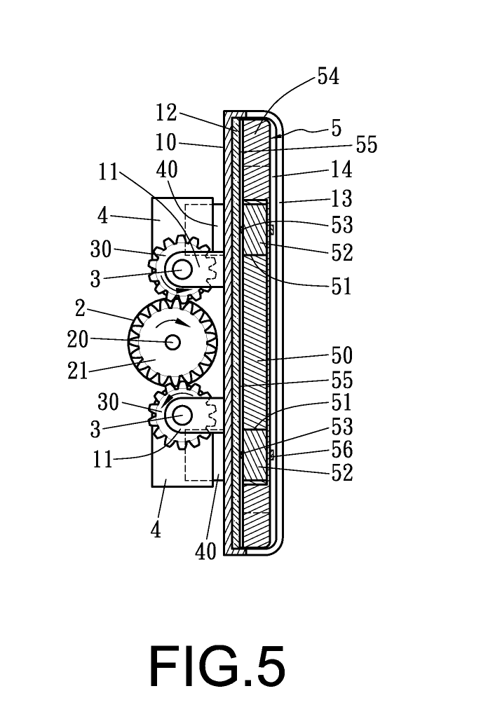

FIG. 6 is a first front view of the preferred embodiment of a wiper for an automobile rearview mirror in the present invention, showing it being operated; and

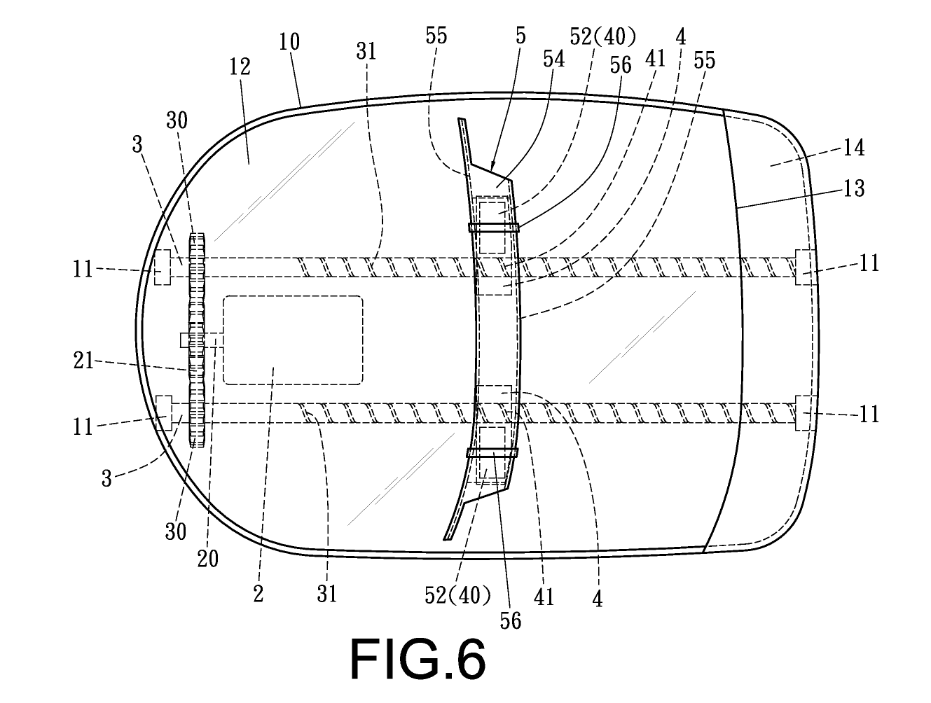

FIG. 7 is a second front view of the preferred embodiment of a wiper for an automobile rearview mirror in the present invention, showing it being operated.

### DETAILED DESCRIPTION OF THE PREFERRED EMBODIMENT

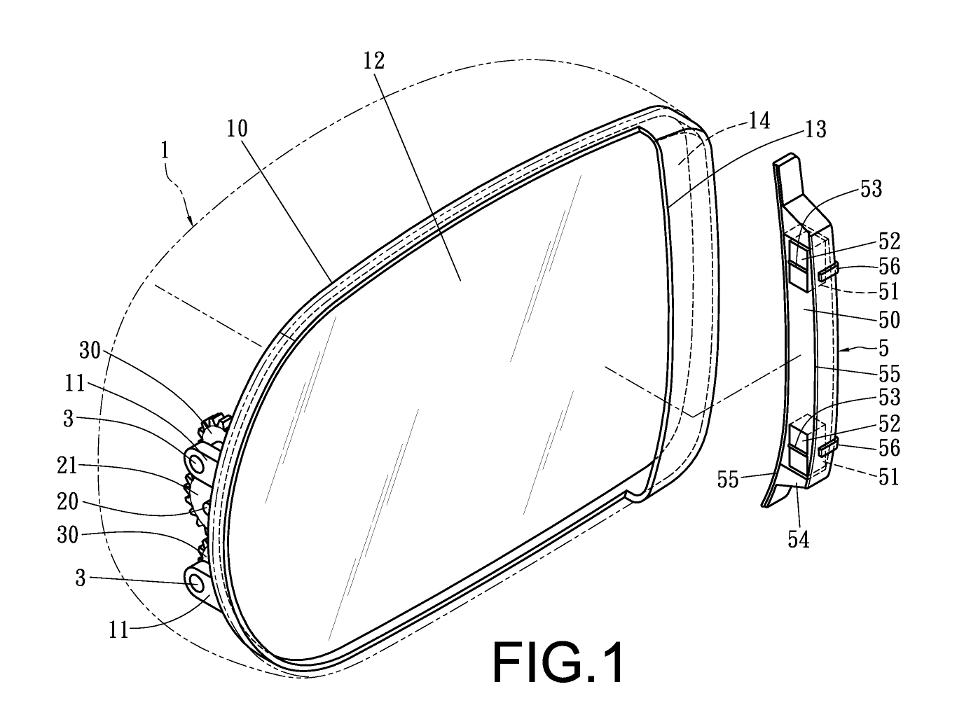

FIGS. 1˜5 show a preferred embodiment of a wiper for an automobile rearview mirror 1, which includes a mirror base 10, a driving motor 2 installed behind the mirror base 10, two supporting shafts 3, two movable bases 4 and a wiper,5.

The mirror 10 is provided with two pairs of positioning ears 11 correspondingly fixed on its rear side, a mirror 12 attached on its front surface, a covering 13 located at one side of its front surface, and a chamber 14 formed inside the covering.

The driving motor 2 is provided with a shaft 20 installed with a driving gear 21.

Each of the supporting poles 3 is fixed between each pair of positioning ears 11 in parallel to each other, provided with a driven gear 30 engaged with the driving gear 21, and plural male threads 31 formed around it.

Each of the movable bases 4 is mounted around each of the supporting poles 3, provided with a magnet 40 fitted inside it to rest on the rear surface of the mirror base 10, and plural female threads 41 used to engage with the male threads 31 of the supporting poles 3. The magnet 40 can be a super magnet.

The wiper 5 is installed on the mirror 12, provided with a positioning base 50 made of plastics, and two recesses 51 formed inside the positioning base 50 and respectively fitted with a super magnet 52 for mutually attracting with the magnet 40 of the movable base 4. A blocking strip 53 is formed across each of the recesses 51, employed to prevent the magnet 52 from directly contacting with the mirror 12 to scrape it. Wrapped around the positioning base 50 is a wiping member 54 made of soft rubber, and projected from two edges of an inner surface of the wiping member 54 are respectively a projecting strip 55 resting on the mirror 12. In addition, at least a locking member 56 is fixed on the wiping member 54, used to keep the wiping member 54 fixed together with the positioning base 50. The wiper of the invention is thus finished.

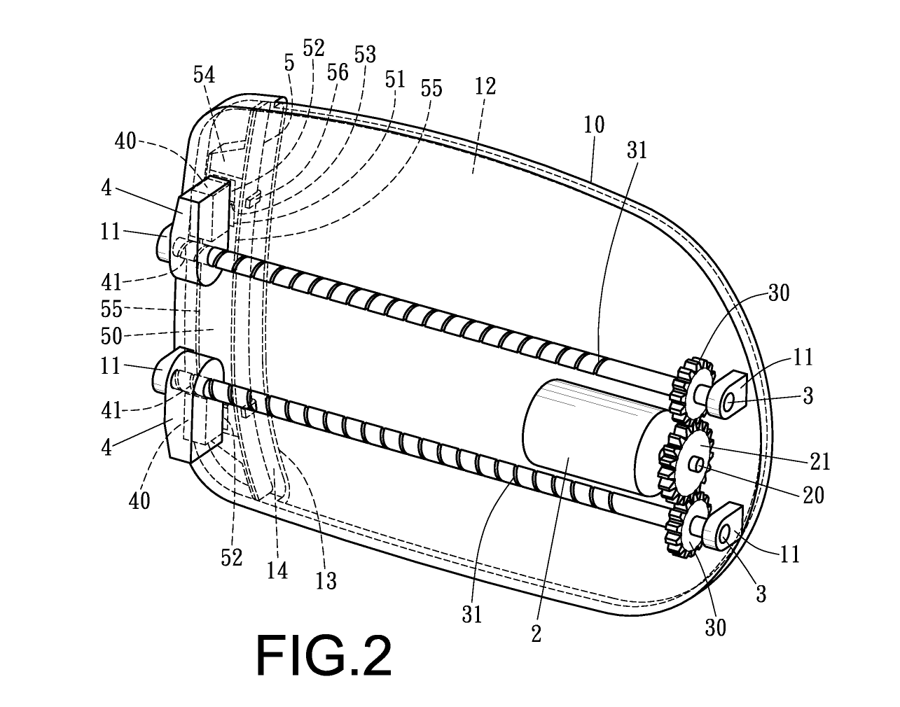

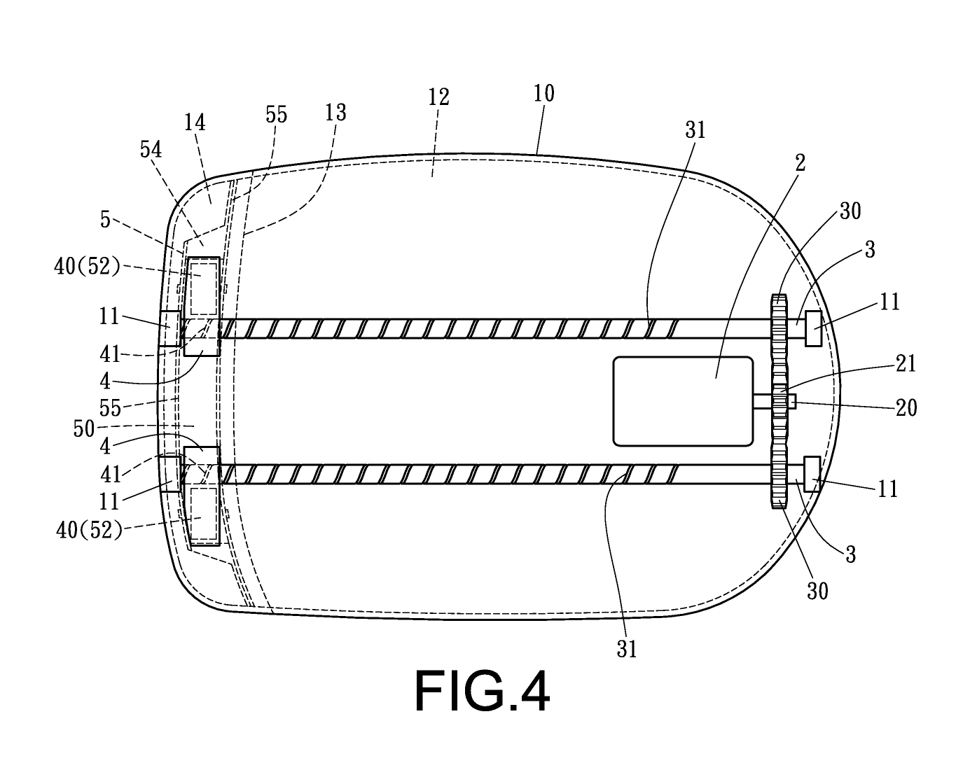

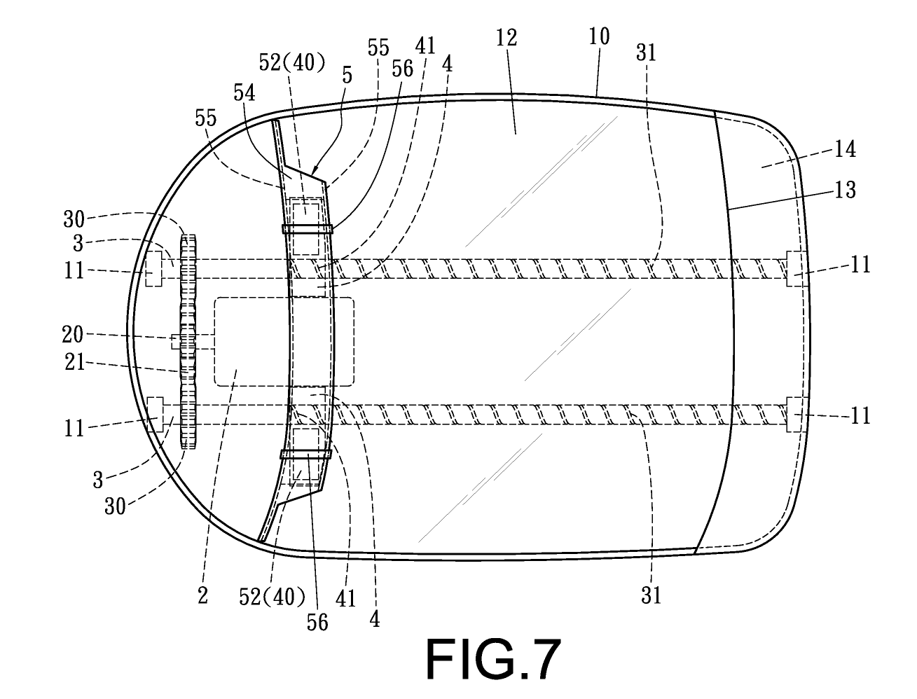

In using, as shown in FIGS. 4˜7, when water drops on the mirror 12 are to be wiped off, the driving motor 2 has to be first turned on to enable the driving gear 21 to drive the two driven gears 30 and the two supporting shafts 3 to whirl. By the time, with the female threads 41 engaged with the male threads 31 of the supporting poles 3, the movable bases 4 are simultaneously driven to move along the supporting shafts 3, and with the magnets 52 of the wiper 5 attracted by the magnets 40 of the movable bases 4, the wiper 5 is thus trailed to move on the mirror 12, enabling the water drops wiped off the mirror 12 by the projecting strips 55 attaching on the mirror 12. Next, as shown in FIG. 7, when the wiper 5 is moved near to the outer edge of the mirror 12, the motor 2 is to start rotating reversely, so that the driving gear 21 is to concurrently drive the two driven gears 30 and the two supporting shafts 3 to whirl reversely, too. Of course, the magnets 40 of the movable bases 4 will drive the wiper 5 to move in a reverse direction, and the water drops on the mirror 12 is to be continuously wiped off by the projecting strips 55 attaching on the mirror 12. Having the wiper 5 reciprocated moving on the mirror 12, the mirror 12 of the rearview mirror 1 can be kept clear to let a driver apparently realize the conditions of other cars behind him. Finally, while the wiper 5 is not to be used, it can be moved into the chamber 14 of the mirror base 10, as shown in FIGS. 2˜4, to be sheltered by the covering 13, not only making it invisible but also lengthening its service life.

While the preferred embodiment of the invention has been described above, it will be recognized and understood that various modifications may be made therein and the appended claims are intended to cover all such modifications that may fall within the spirit and scope of the invention.

What is claimed is:

1. A wiper for an automobile rearview mirror, said rearview mirror comprising a mirror base installed with a motor on its rear surface, said motor provided with a driving gear mounted on its shaft, at least a supporting shaft fixed on said rear surface of said mirror base, at least a driven gear mounted on said supporting pole for engaging with said driving gear of said motor, said supporting shaft provided with plural male threads formed along its surface to movably engage with a movable base that has a magnet fitted inside it to be so close to said rear surface of said mirror base, said movable base provided with plural female threads for engaging with said male threads of said supporting shaft, a wiper installed on a mirror attached on a front surface of said mirror base and provided with at least a magnet fixed inside it to mutually attract with said magnet of said movable base.

2. The wiper for an automobile rearview mirror as claimed in claim 1, wherein said wiper is provided with a positioning base made of plastics and possessing at least a recess for fitting said magnet therein, a blocking strip formed across said recess of said positioning base for preventing said magnet from directly contacting with said mirror to scrap it, a wiping member made of soft rubber and wrapped around said positioning base and having at least a projecting strip formed on its inner surface to attach on said mirror.

3. The wiper for an automobile rearview mirror as claimed in claim 2, wherein said wiper is further provided with at least a locking member located outside said wiping member to keep said wiping member fixed together with said positioning base.

4. The wiper for an automobile rearview mirror as claimed in claim 1, wherein said mirror base is provided with a covering located at one side of its front surface and a chamber formed inside said covering.
